(19) United States
(12) Patent Application Publication
(10) Pub. No.: US 2025/0231987 A1
(43) Pub. Date: Jul. 17, 2025

(54) NEURAL NETWORK PROCESSING

(71) Applicant: Arm Limited, Cambridge (GB)

(72) Inventors: Shyam Tailor, Cambridge (GB); Tiago Manuel Lourenço Azevedo, Cambridge (GB); Partha Prasun Maji, Cambridge (GB)

(73) Assignee: Arm Limited, Cambridge (GB)

(21) Appl. No.: 18/850,850

(22) PCT Filed: Mar. 29, 2023
(86) PCT No.: PCT/GB2023/050808

§ 371 Date: Sep. 25, 2024

(30) Foreign Application Priority Data
Mar. 30, 2022 (GB) 2204552.0

(51) Int. Cl. G06F 16/901; G06F 16/23

(52) U.S. Cl. CPC G06F 16/9024; G06F 16/2379

(57) ABSTRACT

For a set of data points which are desired to be processed according to neural network processing, each data point corresponding to a position in space, data point information indicative of one or more properties of the data points is received (500), and connectivity information indicative of connections between the data points is determined (503). An order for the data points is then determined (504) based on the positions in space of the data points, and updated connectivity information (505) is generated based on the initial connectivity information and the determined order for the set of data points. The updated connectivity information and data point information are provided for further processing (507) to be performed by a processor operable to execute neural network processing.

### BACKGROUND

The technology described herein relates to neural network processing, and in particular to the processing of data corresponding to an array of data points in neural network processing.

It is often desirable to use a neural network to process data in the form of (representing) a “point cloud”, i.e. comprising a set of data points, each data point having a position in space. Examples of such a “point cloud” would be a set of data points identifying points on one or more objects, e.g. objects appearing in virtual or physical space, or appearing in an image.

When processing a “point cloud” using a neural network, it is usually desirable to first try to identify points in the cloud that are or should be considered to be “connected” or “related” to each other. This processing is commonly referred to as “clustering” and is used to generate connectivity data (connectivity information) indicating connections between data points in the point cloud. The “clustered data” may form a graph, wherein the data points form “nodes” of the graph and the connectivity data (connectivity information) indicates the connections (“edges”) between various nodes.

Neural network processing may then be performed using such “clustered” point cloud data, e.g. to classify one or more objects (or parts of objects) represented by the point cloud data. Such neural network processing of “point cloud” “graphs” may be referred to as “graph neural network processing”.

The Applicant believes that there remains scope for improvements to the processing of “point cloud” type data using neural network processing.

### BRIEF DESCRIPTION OF THE DRAWINGS

A number of embodiments of the technology described herein will now be described by way of example only and with reference to the accompanying drawings, in which:

FIG. 1 shows schematically a data processing system which may be configured to perform neural network processing in accordance with embodiments of the technology described herein;

FIG. 2 shows schematically an overview of processing which may be performed for a set of data points;

FIG. 3 shows schematically overview of processing for a set of data points in accordance with embodiments of the technology described herein;

FIG. 4 shows schematically features of a processor in accordance with embodiments of the technology described herein;

FIG. 5 is a flowchart setting out processing steps in accordance with embodiments of the technology described herein;

FIGS. 6A and 6B show example space filling curves in 2D and 3D respectively which may be used to determine an order for data points in embodiments of the technology described herein;

FIG. 6C illustrates how a space filling curve can be used to determine an order for data points based on their positions in space in embodiments of the technology described herein;

FIG. 7 further illustrates some of the processing steps shown in FIG. 2;

FIG. 8A shows connectivity information in the form of an adjacency matrix based on an initial (received) order of data points;

FIG. 8B shows corresponding updated connectivity information in the form of an updated adjacency matrix based on a determined order for the data points as may be generated in embodiments of the technology described herein; and

FIGS. 9A and 9B show a further example adjacency matrix and updated adjacency matrix as may be used in embodiments of the technology described herein.

Like reference numerals are used for like components where appropriate in the drawings.

### DETAILED DESCRIPTION

In one embodiment, the technology described herein comprises a method of operating a data processing system, the data processing system comprising a processor operable to execute neural network processing, the method comprising: receiving for a set of data points, each data point corresponding to a position in space, data point information indicative of one or more properties of the data points, and connectivity information indicative of connections between data points of the set of data points;
determining an order for the data points of the set of data points, based on the positions in space of the data points;
generating updated connectivity information for the set of data points based on the received connectivity information and on the determined order for the data points; and
the processor performing neural network processing using the updated connectivity information for the set of data points.

In another embodiment, the technology described herein comprises a data processing system for performing neural network processing, the data processing system comprising:
a processor operable to execute neural network processing; and
a processing circuit configured to:
for a set of data points, each data point corresponding to a position in space, the set of data points having associated data point information indicative of one or more properties of the data points, and connectivity information indicative of connections between data points of the set of data points:
determine an order for the data points of the set of data points, based on the positions in space of the data points;
generate updated connectivity information for the set of data points based on the connectivity information associated with the set of data points and on the determined order for the data points; and
provide the updated connectivity information for the set of data points and the data point information for the set of data points for processing by the processor.

The technology described herein relates to neural network processing of sets of data points having associated connectivity information, such as may be generated for a point cloud for example. However, in the technology described herein, before processing the set of data points using a neural network, updated connectivity information is generated for the set of data points based on a determined order for the set of data points. In particular, the determined order for the set of data points is based on the positions in space of the data points.

The Applicants have recognised in this regard that data point information for a set of data points to be analysed by neural network processing may be provided in an arbitrary data point order which may not be particularly efficient for performing neural network processing.

Furthermore, this correspondingly means that connectivity information (connectivity data) for such data points may also be in a form which is not particularly efficient for performing neural network processing.

For instance, if the data point order does not reflect the physical proximity or interconnectedness of the data points, then the connectivity information (connectivity data) may have a sparse distribution of connections, connecting various data points which may be distant from one another in the order of data points.

The Applicant has recognised in this regard that connectivity data having sparsely distributed connections (e.g. a sparse adjacency matrix) is not particularly efficient for performing neural network processing. For example, connectivity information having sparse connections (e.g. a sparse adjacency matrix) may have poor data locality and thus poor locality when stored in memory, making writing to and reading from memory inefficient during neural network processing. Connectivity information having sparse connections (e.g. a sparse adjacency matrix) may also be inefficient to compress (and decompress) and thus inefficient to write to (or read from) memory for this reason also during neural network processing.

Furthermore, if connections in the connectivity information are sparsely distributed and include various connections spanning the entire sequence of the data points, then it is unlikely that there will be any easily-identifiable portions of the connectivity information that are free of connections (e.g. there may be few or only small regions of the adjacency matrix having zero or null entries). Therefore, it can be difficult to accelerate neural network processing since the entire connectivity information may need to be considered when performing neural network processing.

As will be discussed further below, the technology described herein addresses this by determining a (new) order for the data points based on the positions in space of the data points, and then generating corresponding updated connectivity information for the set of data points based on the determined (new) order for the data points.

In this regard, the Applicant has recognised that using the positions in space of the data points to inform the (new) order of the data points can allow the order of the data points to better reflect the spatial distribution of data points and the likely connections between data points. In turn, when the updated connectivity information is generated according to the (new) order of data points, the updated connectivity information may comprise a more efficient data structure, e.g. allowing better compression and providing better memory locality than the initial connectivity information, thus allowing improvements to processing speed and efficiency, and to utilisation of hardware resources (e.g. such as memory, bandwidth and processor utilisation), when processing the data using a neural network. For example, a speed of neural network processing (e.g. inferencing) may be improved by using the updated connectivity information as opposed to using the (original) connectivity information (e.g. when using the updated connectivity information as a weight matrix for multiplication with feature map vectors, the feature map vectors e.g. based on the data point information), in terms of the time taken to load data (e.g. comprising the connectivity information) from memory and also the time to perform matrix-vector multiplications. Such processing speed, memory locality, and bandwidth usage improvements may outweigh the additional processing cost associated with generating the updated the connectivity information.

The technology described herein can comprise, and be implemented in and as, any suitable and desired data processing system. Correspondingly, the data processing system of the technology described herein may be implemented as part of any suitable electronic device or devices which may be required to perform neural network processing, e.g., such as a desktop computer, a portable electronic device (e.g. a tablet, mobile phone, wearable device or other portable device), a medical device, automotive device, robotic device, gaming device, or other electronic device. Thus the technology described herein also extends to an electronic device that includes the data processing system of technology described herein (and on which the data processing system operates in the manner of the technology described herein).

The data processing system may comprise any desired components and elements that a data processing system can comprise, such as one or more or all of: a central processing unit (CPU), a graphics processing unit (GPU) (graphics processor), a video processor, a digital signal processor, one or more neural network processors, a display processing unit (display processor), a display and a memory.

One or more (or all) of the processors of the data processing system may be arranged within a system-on-chip system.

The processor operable to execute neural network processing may comprise any suitable processor that is capable of doing that, such as a central processing unit (CPU), a graphics processing unit (GPU) (graphics processor), a video processor, a sound processor, an image signal processor (ISP), a digital signal processor, and a Neural Network Accelerator/Processor. In an embodiment, the processor operable to execute neural network processing is a neural network processor (NPU) which is specifically configured for performing neural network processing.

The processor should, and in an embodiment does, include appropriate processing circuits, logic, etc., suitable for performing neural network processing operations.

The technology described herein processes a set of data points, each data point corresponding to a position in space.

The set of data points may relate to any suitable and desired data points which are desired to be processed by (analysed using) neural network processing. In embodiments, the set of data points relates to one or more virtual or physical objects (in an embodiment with each data point in the set of data points relating to a point on one or more virtual or physical objects).

For example, the one or more virtual or physical objects could be object(s) such as buildings, people, robots, vehicles, furniture, or other objects. The one or more objects may exist in physical space (in reality), or which may exist in virtual space (e.g. existing in a virtual model), or may be object(s) within an image or video.

The set of data points may have been generated (are generated) from any suitable and desired input data, such as image data (one or more image frames), video data (one or more video frames), virtual model data, object tracking data (e.g. GPS data), or sensor data (e.g. from laser scanning, LiDAR, infrared detection, UV detection, visible light detection, or x-ray detection, or other detection). When generated from image or video data, the set of data points may be generated by photogrammetry (in which the position in space of each of the data points is derived from the image or video data). In an embodiment, the set of data points relate to point cloud data detected by a suitable detector, e.g. such as LiDAR.

In an embodiment, the position in space to which each data point corresponds is a position in 2D or 3D space. The position in space may be identified by any suitable and desired coordinates, and in an embodiment by Cartesian coordinates comprising x,y coordinates for 2D space and x,y,z coordinates for 3D space.

In an embodiment the set of data points corresponds to a point cloud, comprising individual (independent) data points having a position described by x and y (and optionally also z) geometric coordinates.

The set of data points that is processed in the technology described herein may correspond to an entire set of (original) input data points (e.g. an entire set of data points from an input point cloud). Alternatively, and in an embodiment, the set of data points that is processed corresponds to (only) part of a set of input data points, in an embodiment comprising a subset of data points from an initial (original) set of input data points. The set of data points that is processed may be generated (selected) from an initial set of input data points by any suitable and desired process.

In embodiments, the set of data points that is processed is selected from a set of input data points according to a downsampling process, in an embodiment such as random sampling or farthest point sampling. In this manner, the number of data points which are to be used for neural network processing may be reduced, reducing the overall time and hardware cost of performing neural network processing.

The set of data points has associated data point information (data point data), the data point information being indicative of one or more properties of the data points. In an embodiment the data point information comprises respective information for each (and every) data point of the set of data points.

In an embodiment, the one or more properties indicated by the data point information comprises a position in space of each data point of the set of data points. Thus, in an embodiment the data point information comprises position information for each (and every) data point in the set of data points, the position information indicating the position in space to which each data point corresponds. In an embodiment the position information comprises x,y coordinates (or x,y,z coordinates) for each data point.

The data point information may comprise only position information. Alternatively, in addition to position information, the data point information may also comprise information about any other suitable and desired property for (each of) the data points. The data point information for a data point may, for example, comprise information relating to (indicative of) a physical property of an object at the position in space to which the data point corresponds. The data point information may comprise, for example one or more of: a colour (e.g. an RGB colour), a surface normal, a transparency, or other property for a (each) data point.

The data point information is in an embodiment in the form of a feature matrix, for the purposes of neural network processing. Thus, in embodiments, the data point information (and in an embodiment, as will be discussed below, the updated data point information) is used for an input feature map of the neural network processing.

The data point information for the data points of the set of data points will be provided in a particular order of the data points. This may be, and in an embodiment is, an “initial” or “raw” data order, e.g. corresponding to an order in which data points were (originally) generated from input data.

For example, for a set of data points relating to a point cloud, the data point information for the data points may be provided in an order of the data points that is the order of the data points for the point cloud.

In addition to data point information indicative of one or more properties of the data points, connectivity information (connectivity data) for the set of data points is also provided. The connectivity information (connectivity data) is indicative of (represents) connections between data points of the set of data points. In an embodiment, each connection indicated is between a pair of data points.

In this regard, the connectivity information sets out (defines) which data points are to be treated as having a connection between them (and thus which data points are to be treated as being connected). A connection between (a pair of) data points (as indicated in the connectivity information) associates those data points with one another.

A connection between data points (as indicated in the connectivity information) may indicate (be based on) any suitable and desired relationship between those connected data points.

In an embodiment, a connection between data points (as indicated in the connectivity information) indicates that those connected data points have respective positions in space which are relatively close to each other. For example, in embodiments, a data point may be connected with one or more (or all) data points having a position in space within a particular, in an embodiment selected, in an embodiment predetermined distance from the position in space of the data point in question, and/or is connected with one or more (or all of) the data points having positions in space which correspond to its k-nearest neighbours (where k is an integer).

In an embodiment, connections between data points (as indicated in the connectivity information) relate to (are based on) only the positions in space of the data points, for example as defined in the (provided) data point information, and in an embodiment does not relate to any other properties of those data points. A connection between data points could alternatively, or additionally, relate to (be based on) any other desired property of those data points (which property may, for example, be indicated in the (provided) data point information).

In this regard, the data points and connectivity information may be considered as a graph, with the data points forming the nodes of the graph and the connectivity information indicating the edges of the graph (and the data point information describing node features).

The (initial) connectivity information provided for the set of data points should, and in an embodiment does, correspond to (is based on) the (initial) data point order (i.e. the data point order in which the data point information is provided for the data points).

In an embodiment, the (initial) connectivity information indicates connections between data points according to the initial (provided) data point order (for example, indicating connections between various positions in the initial (provided) data point order).

The (initial) connectivity information is in an embodiment in the form of a data structure which is configured corresponding to (based on) the initial (provided) order of the data points. In an embodiment, the connectivity information is organised (arranged) in the data structure according to (based on) the initial (provided) order of the data points, in an embodiment such that connections between data points are presented in (occur in) the data structure according to (based on) the initial (provided) order of the data points.

In embodiments, the connectivity information is in the form of an adjacency matrix. In an embodiment the adjacency matrix has rows and columns each corresponding to a respective data point and ordered in the order of the data points, with non-null (non-zero) matrix entries (elements) representing connections between data points, and null (zero) matrix entries (elements) indicating that no connection between data points is present (exists).

Thus, whilst the connectivity information is organised and presented according to the (provided) order of the data points, the connections themselves are in an embodiment based on the properties of the data points (and in an embodiment based on the positions in (real or virtual) space associated with the data points).

In an embodiment the technology described herein includes generating the (initial) connectivity information (that is then updated in the manner of the technology described herein). In an embodiment, generating the connectivity information comprises determining one or more connections (for example, of the type described above) between data points in the set of data points (each connection in an embodiment between a pair of data points).

In an embodiment, the connectivity information is generated by using the data point information for the data points in the set of data points to determine connections between data points (in an embodiment using at least position information indicated in the data point information for the data points, wherein the position information indicates a position in space to which each data point corresponds).

In an embodiment, generating the connectivity information comprises a clustering process, comprising identifying one or more groups (“clusters”) of data points, and identifying or creating connections between various data points within each group. In an embodiment, different groups have fewer (or no) connections between them (compared to the number of connections within each group). Thus, data points in different groups in an embodiment have few (or no) connections between them.

The clustering process may comprise any suitable and desired clustering process. In embodiments, when identifying the groups (“clusters”) of data points, the clustering process uses a k-nearest neighbours (k-NN) algorithm (which operates to find the k nearest neighbours of a data point based on the data points' corresponding positions in space, where k is in integer), or a ball query (which operates to find all data points having a position in space within a specified radial distance of a query position).

For the purposes of neural network processing, the connectivity information may be a weight matrix (with which a feature map, e.g. based on the data point information, is multiplied). In embodiments, the connectivity information is a weight matrix comprising an adjacency matrix.

As noted above, the Applicant has recognised that a set of data points may be provided in an order for which corresponding connectivity information is not in a particularly efficient data form for performing neural network processing. Accordingly, in the technology described herein, a (new) order is determined for the data points based on the positions in space of the data points, and updated connectivity information is then generated based the initial (original) connectivity information and the (new) determined order for the data points.

The determined (new) order for the data points of the set of data points will normally be, and is in an embodiment, different to the (initial) order in which the data points of the set of data points are provided.

In the technology described herein, the (new) order for the data points is determined based on the positions in space of the data points.

In an embodiment, determining the (new) order for the data points based on the positions in space of the data points comprises determining the (new) order for the data points based on the position in space to which each data point corresponds. In an embodiment, the position in space to which each data point corresponds is indicated in the data point information for the data points.

In an embodiment, the determined (new) order for the data points is an order in which data points that are relatively close in the determined (new) order of data points have positions which are relatively close in the (physical or virtual) space that the data points are distributed in, whereas data points which are relatively far apart in the determined (new) order of data points are relatively far apart in the (physical or virtual) space.

In an embodiment, the process of determining the (new) order for the data points is such that data points having positions that are relatively closer in the space that the data points are distributed in will be placed closer together in the determined (new) order than data points which are relatively further apart in the space that the data points are distributed (which data points will accordingly be placed further apart in the determined (new) order). Thus, in an embodiment the processing orders the data points based on their closeness (proximity) in space.

For example, data points A, B and C in the set of data points may occur in an order A, B, C in the initial (provided) order for the set of data points. However, data point A may have an associated position in space which is closer to the position in space of data point C than the position in space of data point B. In this case, the processing for determining the (new) order for the data points may (and in an embodiment does) re-order data points A, B and C corresponding to a (new) determined order A, C, B (or B, C, A, or B, A, C, or C, A, B) such that data point A is closer to (or as close to) data point C in the (new) determined order than data point B.

Hence, in an embodiment, for a first data point (A), second data point (B) and third data point (C) in the set of data points provided in an initial order of the data points, if the first data point has a position in space which is closer to a position in space of the third data point than a position in space of the second data point, then the determining a (new) order for the set of data points will in an embodiment comprise placing the first data point closer to (or as close to) the third data point than the second data point in the determined (new) order for the data points. This may comprise, for example, re-ordering, any one or more of the first, second and third data points (if they were not already in the desired order in the initial (provided) order of the data points).

In an embodiment, the (new) order for the data points is determined by (computationally) traversing the space that the data points are distributed in (occupy) according to a particular, in an embodiment selected, in an embodiment predetermined path, with the (new) order for the data points then being set as the order in which the path encounters (meets) the positions of the data points in the space (i.e. the order in which the data points lie along the path). The path may be any suitable and desired path (curve) through the space occupied by the data points. The path may traverse 2D or 3D space (in an embodiment the path traverses 2D space for data points having positions defined in 2D space, and traverses 3D space for data points having positions defined in 3D space).

The path through space which is used to determine the (new) order of the data points could be discontinuous. However, in embodiments it is a continuous path through space. The path through space should (and in an embodiment does) traverse an (the) entire region of space in which the set of data points are located (distributed). In an embodiment, the path traverses each and every position in (the) space only once and does not cross itself. In an embodiment the path corresponds to a repeating pattern, in an embodiment a fractal curve, more in an embodiment a space filling curve, such as a Hilbert curve or a Morton curve.

In this regard, the Applicants have recognised that such a path can be used to efficiently convert the positions of the data points in (2D or 3D) space into a linear (1D) data point order, in a manner that allows the determined order of the data points to better reflect the closeness of the data points in space and likely connections between data points.

Once an order for the data points based on their positions in space has been determined, updated connectivity information is generated based on the initial (original) connectivity information for the set of data points and on the determined (new) order for the data points.

The updated connectivity information should, and in an embodiment does, present and indicate the connections between the data points in a form that is based on the position of the data points in the (new) determined data point order (rather than being based on the initial data point order). In an embodiment, the updated connectivity information indicates connected positions in the (new) determined data point order.

In an embodiment, generating updated connectivity information comprises updating (re-ordering) the (initial) connectivity information based (only) on the determined (new) order for the data points (and not based on the particular connections indicated in the (initial) connectivity information).

In this regard, generating the updated connectivity information should not, and in an embodiment does not, involve determining any new or different connections for (between) the data points. In an embodiment, the underlying connections represented in both the initial connectivity information and the updated connectivity information remain the same, but the data structure is updated (re-ordered) to reflect the (new) determined data point order. Thus, in an embodiment, the updated connectivity information indicates the same (and the same number of) connections as the initial connectivity information.

The updated connectivity information is in an embodiment in the form of a data structure which is configured corresponding to (based on) the determined (new) order of the data points. In an embodiment, the updated connectivity information is organised (arranged) in the data structure according to (based on) the determined (new) order of the data points, in an embodiment such that connections between data points are presented in (occur in) the data structure according to (based on) the determined (new) order of the data points.

In an embodiment, the updated connectivity information comprises the same type of data structure as the initial connectivity information. In an embodiment, generating the updated connectivity information comprises re-ordering (reorganising) the data point order and thus the indicated connections between the data points in the data structure (as compared to in the (initial) connectivity information), according to the determined (new) data point order, so as to provide an (updated) data structure providing the updated connectivity information.

In embodiments (in an embodiment for initial connectivity information in the form of an adjacency matrix), the updated connectivity information comprises an (updated) adjacency matrix having rows and columns each corresponding to a respective data point and ordered in the determined (new) order of data points, with non-null (non-zero) matrix entries (elements) representing connections between data points, and null (zero) matrix entries (elements) indicating that no connection between data points is present.

Thus, for the case of initial connectivity information in the form of an adjacency matrix, generating updated connectivity information in an embodiment comprises re-ordering the rows and columns of the adjacency matrix to correspond to the determined (new) order for the data points.

The updated connectivity information may comprise an arrangement which is more efficient for performing neural network processing, compared to the received connectivity information.

The Applicants have recognised in this regard that since the (initial) connectivity information is based on the initial (provided) order of data points (which may be an arbitrary order), the connections indicated (presented) in the (initial) connectivity information data structure may have an arrangement resembling a random or arbitrary distribution, with indicated connections being sparsely distributed in the data structure in the sense of being thinly dispersed or scattered.

In comparison, the updated (re-ordered) connectivity information data structure may indicate (present) connections between data points, where the indicated connections in the updated connectivity information data structure have a distribution which is more efficient for performing neural network processing (for example, having indicated connections which are less sparsely distributed).

An improved distribution of indicated connections in the updated connectivity information may result, in the technology described herein, from using the (new) determined order for the data points in order to generate the updated connectivity information, (since the determined (new) order for the data points is based on the positions in space of the data points, and so should better reflect the proximity of data points in space and the likely connections between data points).

Generating updated connectivity information in the manner of the technology described herein, based on the (new) determined order for the data points, in an embodiment results in updated connectivity information having (indicated) connections between data points which are concentrated into one or more regions of the updated connectivity information data structure. Accordingly, the updated connectivity information data structure may, and in an embodiment does, comprise one or more regions having a greater density of (indicated) connections (compared to corresponding regions of the initial connectivity information, and/or compared to the initial connectivity information as a whole). The updated connectivity information data structure may also comprise one or more regions having few or no (indicated) connections between data points.

In embodiments where the connectivity information is in the form of an adjacency matrix and the updated connectivity information is in the form of an updated adjacency matrix, the updated adjacency matrix in an embodiment has the same number of non-null (non-zero) entries indicating connections between data points as the (initial) adjacency matrix. However, in an embodiment the non-null (non-zero) entries (elements) of the updated adjacency matrix are less sparsely distributed than in the (initial) adjacency matrix, with the non-null (non-zero) entries (elements) of the updated adjacency matrix being concentrated into one or more regions of greater density (compared to the (initial) adjacency matrix).

Thus, in an embodiment the updated adjacency matrix has one or more regions having a greater density of non-null (non-zero) entries (compared to those same regions in the (initial) adjacency matrix, and/or compared to the (initial) adjacency matrix as a whole). In an embodiment the updated adjacency matrix also has one or more regions which have few (or no) non-null (non-zero) entries indicating connections between data points.

Such an updated connectivity information data structure (e.g. updated adjacency matrix) may allow for more efficient compression when storing the updated connectivity information (e.g. when writing to the updated connectivity to or reading the updated connectivity information from memory), may have better locality when stored (in memory) allowing more efficient writing to (and reading from) memory, and may allow regions of having few (or no) connections indicated to be ignored when performing further processing such as neural network processing, and thus may assist in accelerating neural network processing (and may improve hardware resource utilisation, such as storage (memory), bandwidth and processor utilisation).

The updated connectivity information could be generated on-the-fly as the (initial) connectivity information is received. However, in an embodiment the (initial) connectivity information is stored (saved in (written to) memory, in an embodiment a main memory of the data processing system) and then used (from memory) when generating the updated connectivity information.

The updated connectivity information may be provided for further processing (by the processor, or otherwise) in any suitable and desired manner. For example, the updated connectivity information could be streamed (to the processor) as it is generated. However, in an embodiment the updated connectivity information is stored (written to memory, in an embodiment a main memory of the data processing system), and is then subsequently used (read from memory) by the processor when it is desired to perform further processing using this data.

In an embodiment the updated connectivity information is compressed before storage (writing to memory), and decompressed for use (when reading from memory). As noted above, the updated connectivity information may be in a form which can be more efficiently compressed (and decompressed) than the (initial) connectivity information. The updated connectivity information may also have better locality in storage (memory) than the (initial) connectivity information.

In an embodiment, updated data point information is also generated based on the determined (new) order for the data points (and based on the initial (original) data point information).

In an embodiment, generating the updated data point information comprises re-ordering the data point information according (only) to the order of data points in the determined (new) order for the data points (and not based on the properties indicated in the data point information itself).

In this regard, updating the data point information in an embodiment does not involve altering the underlying properties (property information) indicated by the data point information. In an embodiment, the one or more properties indicated in the (initial) data point information and the updated data of point information are the same, but their order in the data structure storing the data point information is updated (re-ordered) to reflect the (new) determined data point order.

In an embodiment, the updated data point information comprises the same type of data structure as the initial data point information. In embodiments (in an embodiment where the received data point information is in the form of a feature matrix), the updated data point information comprises an (updated) feature matrix in which the data point information is ordered according to the determined (new) order of data points.

The updated data point information could be generated on-the-fly as the (initial) data point information is received. However, in an embodiment the (initial) data point information is stored (written to memory, in an embodiment a main memory of the data processing system), and then used (read from memory) when generating the updated data point information. In an embodiment the (initial) data point information is stored (in memory) according to the order in which it is generated for the set of data points.

In embodiments where updated data point information is generated, the updated data point information should be, and is in an embodiment, provided and used for further processing (e.g. neural network processing to be performed by the processor) (and not the (initial) data point information).

The data point information may be provided for further processing (e.g. by the processor) in any suitable and desired manner. For example, data point information could be streamed to the processor (for example, with updated data point information being streamed as it is generated). However, in an embodiment the data point information is stored (written to memory, in an embodiment to a main memory of the data processing system), and is then subsequently used (read from memory) by the processor when it is desired to perform further processing using this data. In an embodiment, the updated data point information (where generated) is stored (in memory) according to the determined (new) order for the data points. This will tend to mean that the updated data point information should have better locality when stored (in memory) than the (initial) data point information.

In an embodiment, the determining of a (new) order for the data points can be selectively disabled, e.g., and in an embodiment, depending on an order in which the data points are (initially) provided. The Applicants have recognised in this regard that in some circumstances the data points may be received in an order which already reflects the positions in space of the data points, such that it may not be necessary to determine a (new) order for the data points. When the determining of a (new) order for the data points is disabled, the generating updated connectivity information (and generating updated data point information) is in an embodiment likewise disabled.

In embodiments, the generating of updated connectivity information (and the generating of updated data point information) can be additionally (or alternatively) selectively disabled, e.g., and in an embodiment, based on a comparison of the determined (new) order for the data points and the order in which the data points were (initially) provided. The Applicant has recognised in this regard that if the determined order for the data points is the same as (or similar to) the order in which the data points were received, then it may not be necessary to generate updated connectivity information (and it likewise may not be necessary to generate updated data point information). When the generating of updated connectivity information (and the generating of updated data point information) are disabled, then the information which is provided for further processing such as neural network processing by the processor is in an embodiment the initial (original) connectivity information (and the initial (original) data point information).

The processing relating to determining an order for the data points, generating updated connectivity information (and in an embodiment also generating updated data point information) can be performed by any suitable and desired, and appropriately configured processing circuit (and in embodiments a (dedicated) processing circuit is provided for that purpose). The Applicant has recognised that improvements to neural network processing speed, memory locality, and bandwidth usage may outweigh the additional hardware and processing costs associated with providing this processing circuit. In embodiments, this processing circuit is configured as part of (incorporated within) the processor which is operable to perform (and which performs) the neural network processing (e.g. an NPU). Alternatively, this processing circuit may be provided as a (separate) processing circuit (e.g. as a hardware accelerator) in addition to the processor which is operable to perform (and which performs) the neural network processing (e.g. NPU).

The determining an order for the data points, and generating updated connectivity information (and updated data point information) can be performed as and when required for neural network processing (e.g. at or during run-time for the neural network processing), and in embodiments this is done.

Alternatively, the determining an order for the data points, and generating updated connectivity information (and updated data point information) could be performed by an appropriately configured processing circuit in an “offline” process (e.g. outside of run-time for the neural network processing), with the updated connectivity information (and updated data point information) being stored (in memory), and then being used (read from memory) during (later) neural network processing), and in embodiments this is done.

Hence, in one embodiment, the technology described herein comprises a processing circuit for processing a set of data points, each corresponding to a position in space, the set of data points having associated data point information indicative of one or more properties of the data points, and connectivity information indicative of connections between data points of the set of data points, the processing circuit configured to:
determine an order for the data points of the set of data points, based on the position in space of the data points; and
generate updated connectivity information for the set of data points based on the connectivity information associated with the set of data points and on the determined order for the data points.

In another embodiment, the technology described herein comprises a method of processing a set of data points, each data point corresponding to a position in space, the set of data points having associated data point information indicative of one or more properties of the data points, and connectivity information indicative of connections between data points of the set of data points, the method comprising:
determining an order for the data points of the set of data points, based on the positions in space of the data points; and
generating updated connectivity information for the set of data points based on the received connectivity information and on the determined order for the data points.

As will be appreciated by those skilled in the art, embodiments of the technology described herein may, and in an embodiment do, include any one or more or all of the features of the technology described herein, as appropriate.

The neural network processing that is performed (by the processor) using the updated connectivity information and the data point information (whether updated or not) for a set of data points may comprise any suitable and desired neural network processing that may be performed with and for such data, in an embodiment comprising one or more layers of processing. In an embodiment, the data is subjected to, and used for, graph neural network (GNN) processing.

In embodiments, the processor uses both the updated connectivity information and the data point information (whether updated or not) for the neural network processing. In an embodiment the updated connectivity information and the data point information are used as inputs for (one or more layers of) the neural network processing. In an embodiment, both the updated connectivity information and the data point information are used (together) as an input for at least one layer (in embodiments for at least the first layer) of the neural network processing.

In embodiments, the neural network processing comprises (a first layer of processing comprising) aggregation processing for the data points, for example by using a suitable aggregation function. The aggregation processing may operate to modify data point information for a (each) data point (node) based on data point information of other data points (nodes) to which the data point is connected. The aggregation processing may operate on the (updated) data point information (e.g. feature matrix), based on the updated connectivity information (e.g. adjacency matrix).

The neural network processing may (subsequently) comprise one or more (other) layers of neural network processing. The layers of neural network processing may be performed in sequence, with output data from a layer of neural network processing forming the basis of input data for a subsequent layer of neural network processing, to ultimately provide a useful output. The neural network processing layers may comprise any of, for example, a multilayer perceptron (MLP), fully connected layers, convolutional layers, activation layers (e.g. applying a sigma function), pooling layers (e.g. performing max pooling), or other types of layer. Each layer of neural network processing may process (e.g. modify) either or both of the (updated) data point information (feature matrix) and the (updated) connectivity information (adjacency matrix).

The data point information (e.g. feature matrix) and connectivity information (e.g. adjacency matrix) may be stored (in memory), being used (read from memory) when required for neural network processing (in an embodiment being read from memory for each layer of neural processing which requires that data, being modified by the layer of neural network processing, and being written to memory in the modified form after the layer of neural network processing has been performed).

In an embodiment, (only) one or more regions of the updated connectivity information are used for the neural network processing (rather than using the updated connectivity information in its entirety). For example, neural network processing may be performed using (only) regions of the connectivity information having a relatively dense arrangement (occurrence) of indicated connections (such that regions of the connectivity information having few or no connections indicated are not used for the neural network processing).

The neural network processing may use the connectivity information and data point information to provide any suitable and desired (useful) output. For example, the neural network processing may comprise using the connectivity information and data point information to train a neural network or to perform inferencing (in which a trained neural network infers a result from the data point information and connectivity information).

Some example inferencing results which a neural network may be configured to determine are: data point (node) classifications (determining a classification for one or more nodes), e.g. for input data corresponding to an image of a human, determining whether a node corresponds to a nose, ear, hair etc.; connection prediction (where is it predicted whether one or more nodes should be connected), e.g. for input data corresponding to the positions of robots over time, determining a connected path through which a robot has moved) and graph classification (where a classification is determined for the whole or part of a graph), e.g. for input data corresponding to an image of a human hand, identifying a gesture performed by the human hand.

Of course, the neural network processing could be configured to provide other inferencing results, as desired. In embodiments, the neural network processing is configured to perform one or more of: scene analysis for a physical or virtual scene; video analysis; and image analysis. For example, the neural network processing could be configured to perform one or more of: moving object trajectory prediction (e.g. for robots or surveillance), temporal processing on video (e.g. on 3D video), pose estimation (e.g. to estimate human poses), hand gesture recognition, face/object identification, segmentation of 3D objects (e.g. segmentation of a point cloud), video scene analysis, and SLAM (simultaneous localisation and mapping).

The data processing system may comprise and/or be in communication with one or more memories (such as the memories described above) that store the data described herein, and/or store software for performing the processes described herein. The data processing system may comprise and/or be in communication with a host microprocessor, and/or with a display for displaying output data associated with the neural network processing.

The data processing system of the technology described herein may be implemented as part of any suitable system, such as a suitably configured micro-processor based system. In some embodiments, the technology described herein is implemented in a computer and/or micro-processor based system.

The various functions of the technology described herein may be carried out in any desired and suitable manner. For example, the functions of the technology described herein may be implemented in hardware or software, as desired. Thus, for example, the various functional elements of the technology described herein may comprise a suitable processor or processors, controller or controllers, functional units, circuits, processing logic, microprocessor arrangements, etc., that are operable to perform the various functions, etc., such as appropriately dedicated hardware elements (processing circuits) and/or programmable hardware elements (processing circuits) that can be programmed to operate in the desired manner. It should also be noted here that, as will be appreciated by those skilled in the art, the various functions, etc., of the technology described herein may be duplicated and/or carried out in parallel on a given processor. Equally, the various processing circuits may share processing circuits, etc., if desired.

Furthermore, any one or more or all of the processing stages of the technology described herein may be embodied as processing stage circuitry, e.g., in the form of one or more fixed-function units (hardware) (processing circuitry), and/or in the form of programmable processing circuitry that can be programmed to perform the desired operation. Equally, any one or more of the processing stages and processing stage circuitry of the technology described herein may be provided as a separate circuit element to any one or more of the other processing stages or processing stage circuitry, and/or any one or more or all of the processing stages and processing stage circuitry may be at least partially formed of shared processing circuitry.

It will also be appreciated by those skilled in the art that all of the described embodiments of the technology described herein may include, as appropriate, any one or more or all of the features described herein.

The methods in accordance with the technology described herein may be implemented at least partially using software e.g. computer programs. It will thus be seen that when viewed from further embodiments the technology described herein comprises computer software specifically adapted to carry out the methods herein described when installed on data processor, a computer program element comprising computer software code portions for performing the methods herein described when the program element is run on data processor, and a computer program comprising code adapted to perform all the steps of a method or of the methods herein described when the program is run on a data processing system.

The technology described herein also extends to a computer software carrier comprising such software which when used to operate a data processing system causes in a processor, or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

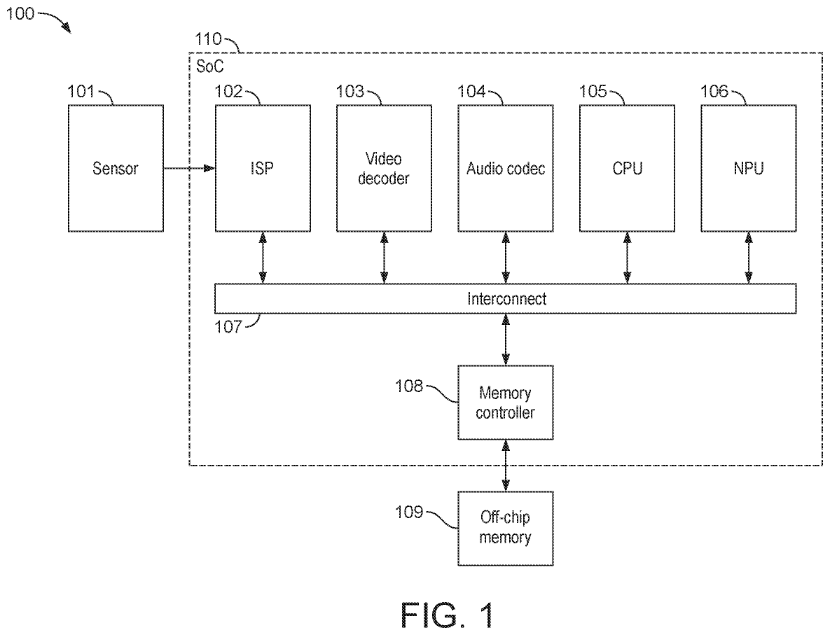

FIG. 1 shows schematically a data processing system 100 system which may be configured to perform neural network processing in the manner of the technology described herein. The system 100 comprises a System on Chip (SoC) 110. Parts of the data processing system which may be on chip comprise an image signal processor (ISP) 102, a video decoder 103, an audio codec 104, a CPU 105 and a neural network processor (NPU) 106, which may be operably connected to a memory controller 108 by means of a suitable interconnect 107. The memory controller 108 may have access to external, off-chip, main memory 109.

A sensor 101 may provide input data for the system 100. The sensor may provide any suitable and desired sensor data, e.g. video data from a camera, sound data from a microphone, point cloud data from a LiDAR device, laser scanning data, infrared detection data, UV detection data, visible light detection data, x-ray detection data, or other sensor data.

Although a CPU 105 and NPU 106 are shown separately in FIG. 1, processing relating to neural networks could be executed by the CPU 105 or another processor such as a GPU, if desired.

The system on chip may also comprise one or more local (on-chip) memories, which the NPU 106 (or other processor executing neural network processing) can access when performing processing.

Although the data processing system shown is of the form of a system-on-chip, the data processing system could alternatively (or additionally) comprise a distributed processing system (comprising a plurality of computing devices), or a cloud-based processing system, or any other suitable and desired data processing system.

The data processing system of the present embodiments may be part of any suitable electronic device which may be required to perform neural network processing, e.g., such as a desktop computer, a portable electronic device (e.g. a tablet, mobile phone, wearable device or other portable device), a medical device, automotive device, robotic device, gaming device, or other electronic device.

In the present embodiments, and in accordance with the technology described herein, a data processing system processes (is configured to process) a set of data points each corresponding to a position in space, in which an order for the data points is determined based on the position space of the data points, and connectivity information for the set of data points is updated based on the determined order for the data points. As noted above, updating the connectivity information in this way may provide updated connectivity information which is in a form that is more efficient for performing neural network processing (compared, e.g., to connectivity information based on an initial data point order).

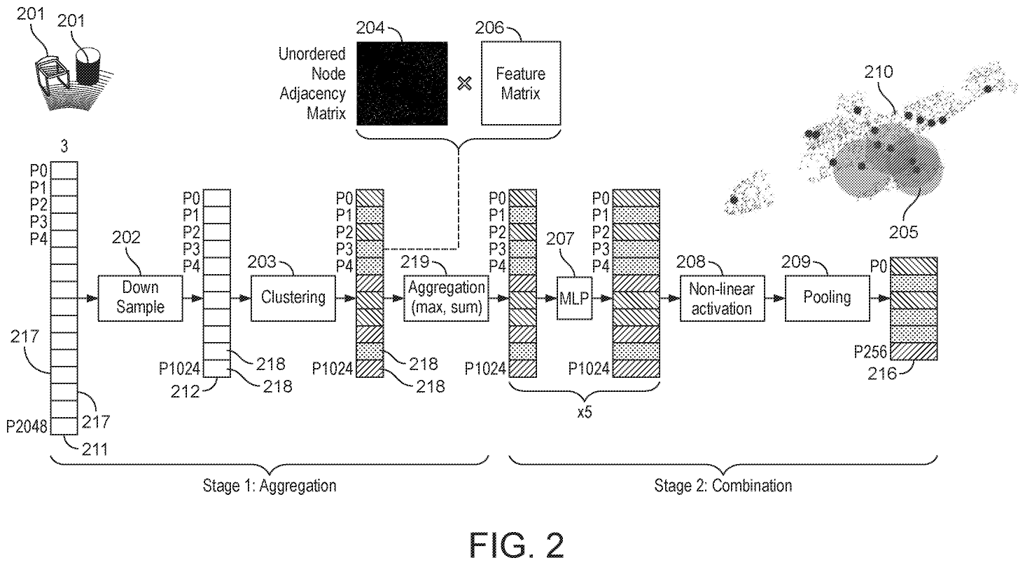

FIG. 2 shows various processing steps which may be performed when processing a set of data points of this type. Albeit, for the sake of comparison, FIG. 2 illustrates a situation where connectivity information is based on an initial data point order (and is not updated).

As shown in FIG. 2, input data 211 may be received relating to a set of input data points 217, and in a particular order of the data points (P0, P1, P2, P3, P4, . . . P2048). Whilst 2048 data points are shown in the input data 211 of FIG. 2, the processing system may be adapted to receive fewer or more data points if desired.

The input data points 217 each correspond to a position in space. For example, the input data points 217 could correspond to points on one or more objects in space 201 (in the case shown, the objects being a chair and table). The input data 211 could comprise data from, e.g. any suitable and desired sensor, or from image or video data. In the example shown in FIG. 2, the input data points 217 are points of a point cloud.

Each input data point 217 of the set of input data points 211 comprises data point information indicative of one or more properties of the data point. The data point information in an embodiment identifies a position in space to which the data point corresponds. The data point information may also include information about any other desired properties of the data point (e.g. indicating a colour, texture, transparency, surface normal).

The input data points 217 may be provided for further processing (e.g. stored in memory) in the order in which they are received (shown as P0, P1, P2 . . . P2048).

The input data points 217 may be downsampled 202 to form a set of data points 212 to be analysed by neural network processing. The downsampling may be performed using, e.g., random sampling or farthest point sampling.

The data point information for the set of data points 212 to be analysed may be received (provided), e.g. according to the order of the data points in the input data 211, or according to the order in which the data points are selected during the downsampling 202. The data point information for the set of data points may be provided for further processing (e.g. stored in memory) according to the provided order of the data points for the set of data points. In FIG. 2 the order in which the data points (218) are provided is shown as P0, P1, P2 . . . P1024).

Whilst 1024 data points form the set of data points 212 to be analysed in FIG. 2, the processing system may be adapted to analyse fewer or more data points if desired.

The received order for the data points 218 of the set of data points 212 may in effect be an arbitrary order, which does not depend on any particular properties of the data points (and in particular does not depend on the positions in space of the data points). For example, the received order for the data points 218 may correspond to an order that the data points in the point cloud are generated.

A clustering process 203 is performed to generate connectivity information for the set of data points 212 to be analysed, the connectivity information indicating connections between data points of the set of data points 212.

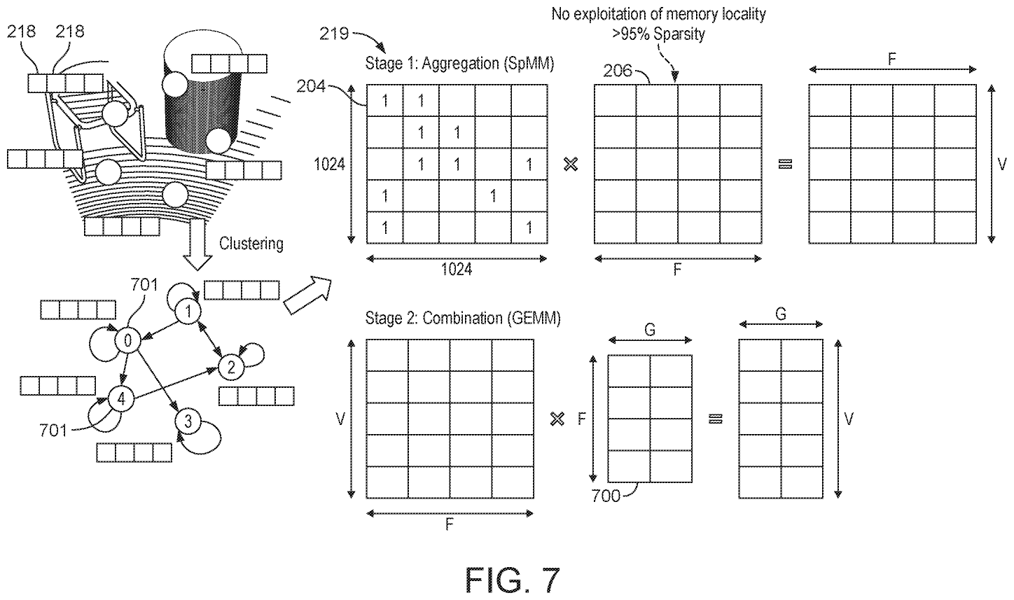

The clustering process 203 may operate to assign data points 218 to groups (“clusters”), e.g. based on the proximity of data point positions in space, e.g. using a k-nearest neighbours (kNN) or ball query. One or more (or all) data points within a cluster may be connected (whereas few or no connections may exist between different clusters). A clustering process is illustratively shown in FIG. 7, which shows data points 218 being grouped into clusters 701. Alternatively, any suitable and desired process may be used to generate the connectivity information.

The data points and connectivity information may be considered as a graph, with each data point forming a “node” of the graph and the connections between data points forming “edges” of the graph.

In FIG. 2, data points 218 within the same group (“cluster”) are shown with the same shading. Since the received order of the data points 218 is an arbitrary order, data points belonging to the same cluster are not necessarily adjacent one another in the received order of data points. If the data point information is stored in received order in memory, this will lead to poor memory locality.

In FIG. 2, the connectivity information is in the form of an adjacency matrix 204.

The adjacency matrix 204 has rows and columns each corresponding to a data point in the set of data points 218 to be analysed and arranged in the received order of data points 218. A matrix entry (element) is set to non-zero (non-null)(e.g. 1) where there is a connection between the data points in question, and to zero (null) where no connection between the data points in question is present (exists)(that has been generated by the clustering process). In FIG. 2, non-zero matrix elements are shown as white dots in the adjacency matrix 204.

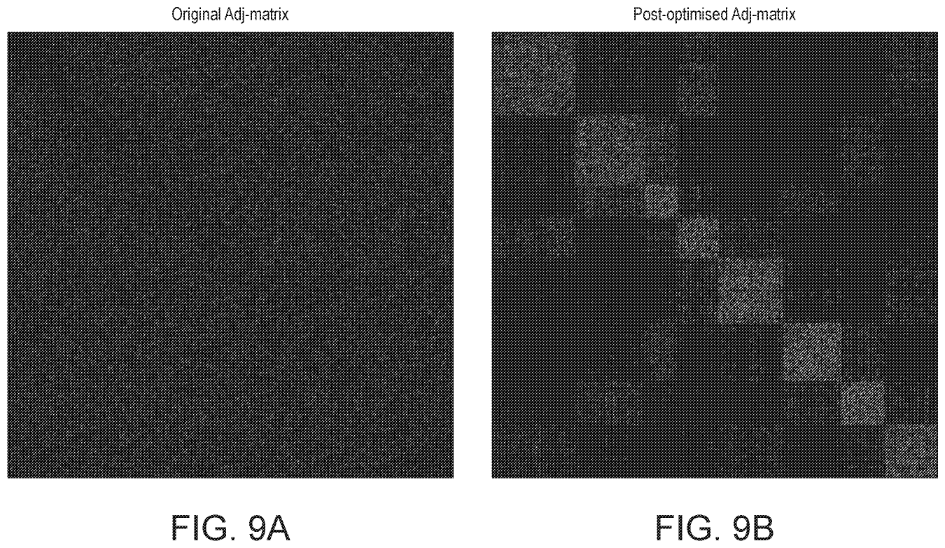

Since the received order of data points 218 is an arbitrary order, which does not reflect the positions in space or likely connections for the data points 218, the matrix entries representing the connections will usually be sparsely distributed. This can be seen in the adjacency matrix 204 of FIG. 2. FIG. 9A is an enlarged view of a similar adjacency matrix based on an arbitrary order of data points.

As discussed above, the Applicant has recognised that an adjacency matrix having such a sparse distribution of entries is not particularly efficient for performing neural network processing. Such an adjacency matrix may have poor locality when written to memory, and may be difficult to compress.

In FIG. 2, the data point information forms a feature matrix 206, the feature matrix comprising a “representation” of each data point based on the data point information.

Similarly to the adjacency matrix 204, the feature matrix 206 is ordered according to the received order of the data points 218. The feature matrix 206 may similarly have poor memory locality.

As shown in FIG. 2, the connectivity information (adjacency matrix 204) and data point information (feature matrix 206) are provided for neural network processing (219, 207, 208, 209).

The neural network processing (219, 207, 208, 209) comprises layers of processing, performed one after another, such that the output from one layer of neural network processing forms the input for next layer of neural network processing. The output from the neural network processing may be any suitable and desired output inferred from the connectivity information and data point information.

Each layer of neural network processing may produce modified data point information (e.g. a modified feature matrix comprising modified a “representation” for each data point) and/or modified connectivity information (e.g. a modified adjacency matrix).

The neural network processing shown in FIG. 2 comprises a first layer of processing comprising aggregation processing 219, which operates to modify data point information for each data point 218 based on data point information of other data points to which the data point is connected. For example, each data point's information (“representation”) may be sent to its corresponding connected neighbours, with an aggregation function then calculated for each data point e.g. by selecting a maximum value of the gathered data point information or by summing values of the gathered data point information.

The aggregation processing 219 thus uses both the data point information (feature matrix 206), and the connectivity information (adjacency matrix 204) to identify which connected data points to aggregate.

With reference to FIG. 7, the aggregation processing 219 may be referred to as Sparse Matrix-Matrix multiplication (SpMM). The adjacency matrix 204 is sparse (typically much sparser than shown in FIG. 7, typically having >70% sparsity) and so the SpMM is typically inefficient.

Furthermore, since the feature matrix 206 is based on the received order of data points, it typically has poor memory locality. Reading the feature matrix from (and writing the feature matrix to) memory is therefore inefficient, since the data point information (“representations”) for connected data points are not necessarily close together in the received data point order and thus not necessarily stored close together in memory.

Whilst aggregation processing 219 is shown in FIGS. 2 and 7, other operations using both the connectivity information (weight matrix) and data point information (feature matrix) could additionally or alternatively be performed if desired.

After aggregation 219, further layers of neural network processing may be performed.

The neural network processing may comprise a feed-forward neural network. FIG. 2 shows neural network processing layers comprising a multilayer perceptron (MLP) 207, which may comprise one or more fully connected layers and/or one or more convolutional layers. The data point information (feature matrix) (and/or the connectivity information (adjacency matrix)) for the set of data points may be passed through the MLP multiple times, e.g. 5 times as shown in FIG. 2.

Alternatively, other types of neural network processing could be used, e.g. such as a recurrent neural network.

In the example shown in FIG. 2, after the MLP 207, activation (non-linear activation) 208 is performed, e.g. by applying a suitable activation function such as ReLU or tanh. This activation 208 could however be omitted.

Pooling 209 is then performed, such as average pooling or in an embodiment max pooling. The pooling layer may act to reduce the size of the feature matrix (by reducing the number of data point “representations”). This can be seen with reference to output information (data) 216 which comprises fewer data point representations (labelled as P0 to P256).

The neural network processing performed after aggregation 219 (such as the MLP 207, activation 208, and pooling 209) are in an embodiment all of the type General Matrix to Matrix multiplication (GEMM). GEMM is illustrated in FIG. 7, and in an embodiment comprises modifying the feature matrix based on multiplication with another matrix (kernel), e.g. comprising a weight matrix 700.

The output information (data) 216 from the neural network processing may comprise any desired and suitable output, such as a classification based on the data points that have been processed. In the case of input data which corresponds to a point cloud, the output data may identify a region (a “segment”) of the point cloud corresponding to a region of an object. For the example point cloud 210 relating to an aeroplane shown in FIG. 2, the output data identifies at least a segment 205 corresponding to a wing of the aeroplane.

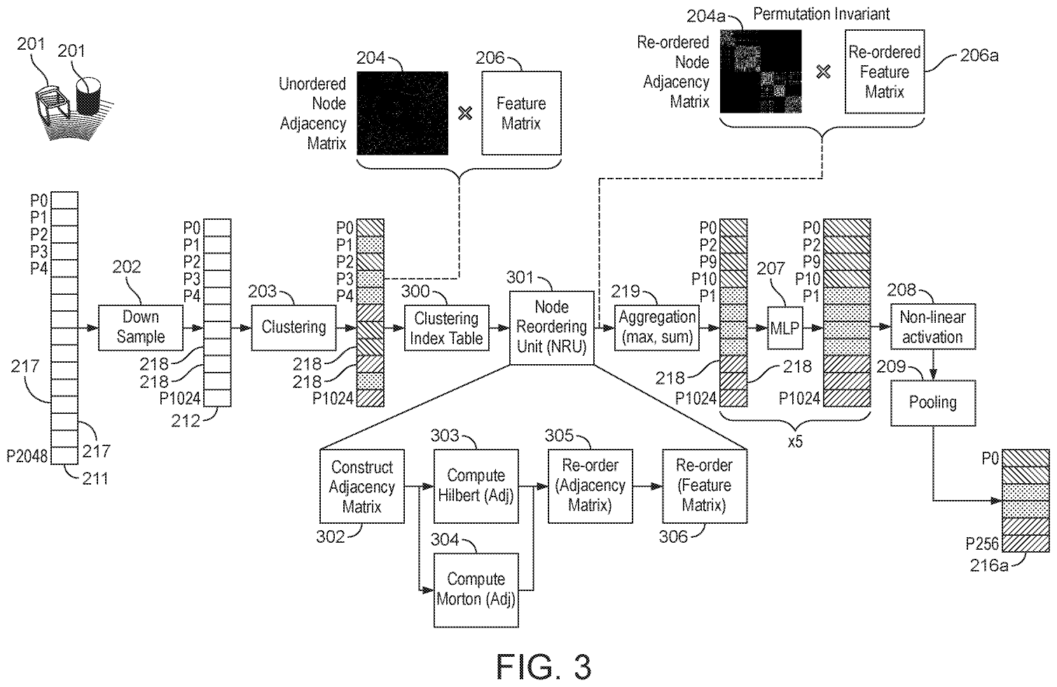

As noted above, the Applicant has recognised that an adjacency matrix 204 (and feature matrix 206) of the type shown in FIG. 2, which are based on the (initial) received order of data points, are not in a form that is particularly efficient for performing neural network processing. Thus, in embodiments of the technology described herein, updated connectivity information (e.g. an updated adjacency matrix), and in an embodiment also updated data point information (e.g. an updated feature matrix), are generated based on a determined order of the data points which is based on the positions in space of the data points. The Applicant has recognised that updating the connectivity information (and the data point information) in this manner may provide updated connectivity information (and updated data point information) which are in a form that is more efficient for performing neural network processing. An embodiment of this process (and that is in accordance with the technology described herein) is illustrated in FIG. 3.

Like reference numerals in FIGS. 2 and 3 refer to like processes.

As shown in FIG. 3, in this embodiment, like in the process shown in FIG. 2, an (initial) adjacency matrix 204 and an (initial) feature matrix 206 are generated according to the received order of data points 218 (shown as P0, P1, P2 . . . P1024). As noted above, the received order of data points 218 does not necessarily reflect the proximity of the data points in space or their likely connections.

As shown in FIG. 3, in this embodiments, various processing is performed to generate an updated adjacency matrix 204a, and to generate an updated feature matrix 206a. In an embodiment at least part of this processing is performed by an appropriately configured circuit or circuits (the Node Reordering Unit (NRU)) 301.

In the embodiment shown in FIG. 3, the clustering process 203 comprises generating a clustering index table 300 which contains an assignment between each data point and its corresponding cluster, and constructing the (initial) adjacency matrix (see processing stage 302). As shown in FIG. 3, constructing the (initial) adjacency matrix (processing stage 302) could be performed by the NRU, if desired.

The NRU 301 determines a (new) order for the data points based on the positions in space of the data points. The (new) order is determined based on the order in which a Space Filling Curve (SFC) passes through the positions in space of the data points (see processing stages 303, 304 in which a space filling curve comprising a Hilbert curve or Morton curve are used). In this regard, a space filling curve is a type of curve which passes through each point in space only once, without crossing itself.

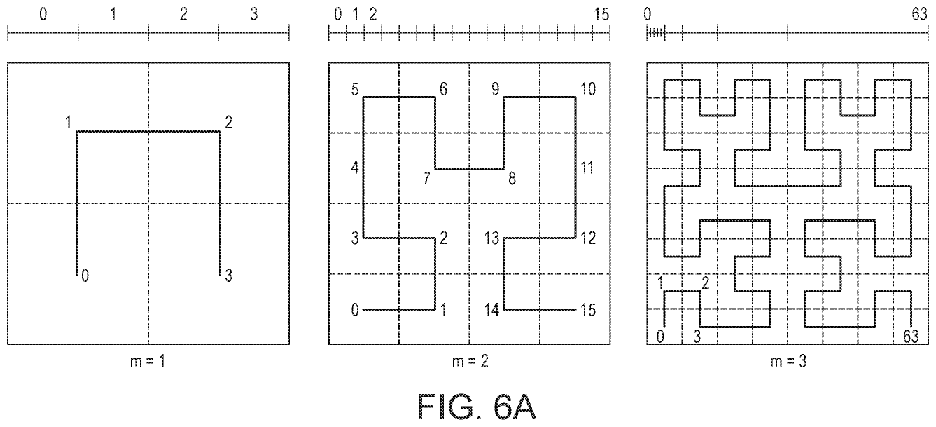

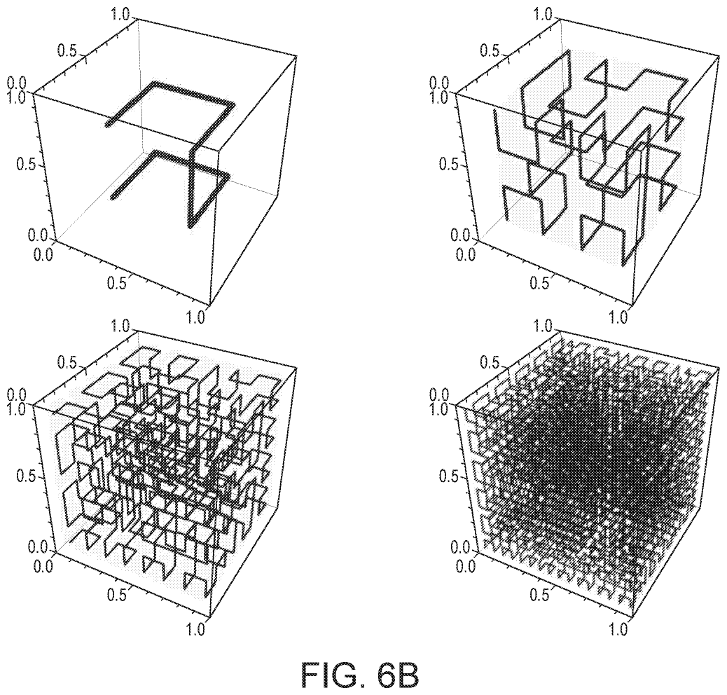

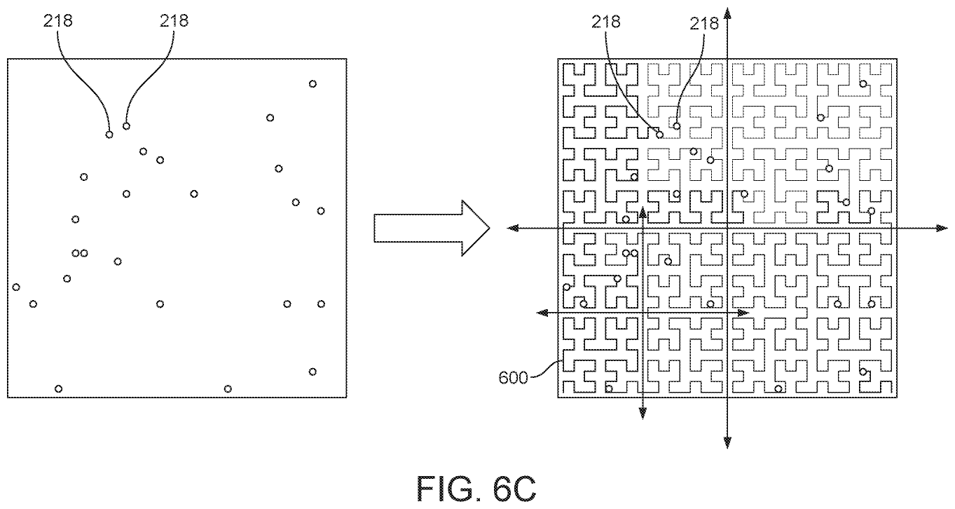

Example Hilbert curves are shown in FIGS. 6A and 6B. The Hilbert curves shown in FIG. 6A are 2D curves, which may be used for data points having a position specified in 2D space. The Hilbert curves shown in FIG. 6B are 3D curves, which may be used for data points having a position specified in 3D space.

FIG. 6C illustrates a Hilbert curve following a path in 2D space which passes through the positions in space of the data points 218 in a set of data points which are to be analysed by neural network processing. The order in which the curve passes through the data point positions is used as the determined (new) order for the data points.

As illustratively shown in FIG. 6C, when following a space filling curve, the order in which data points are passed through generally reflects the closeness of those points in space, and the likely connections between those data points.

Traversing space according to the path of the space filling curve, as discussed above and shown in FIG. 6C for example, in effect converts the positions of the data points in (2D or 3D) space into a linear (1D) data point order. The connectivity information and data point information can then be updated (e.g. re-ordered) according to the determined linear (1D) data point order.

If desired, a different curve (path) through space could be used to determine the (new) order for the data points. For example, a Morton curve could be used. The Morton space filling curve could be implemented using any suitable and desired algorithm, for example:

def get_morton_key(level, x, y):
key = 0
for i in range(level):
key |= (x & 1) << (2 * i + 1)
key |= (y & 1) << (2 * i)
x >>= 1
y >>= 1
return key

As shown in FIG. 3, after determining an order for the data points using a space filling curve (processing stages 303, 304), the NRU 301 then generates (see processing stage 305) updated connectivity information in the form of an updated (re-ordered) adjacency matrix 204a. In particular, the updated adjacency matrix 204a is generated based on the initial adjacency matrix 204 and the determined order for the data points based generated using the space filling curve (from processing stages 303, 304).

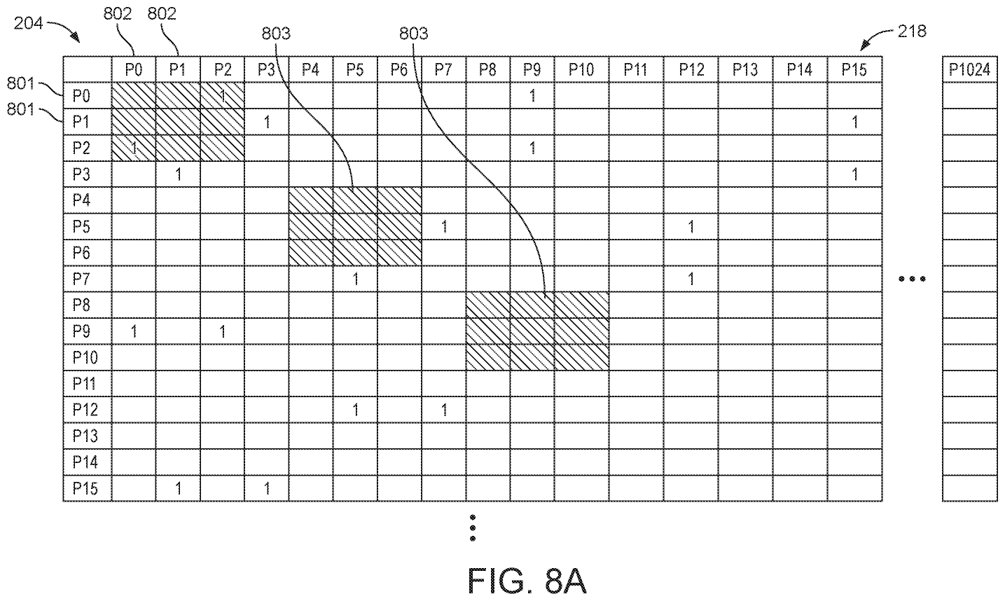

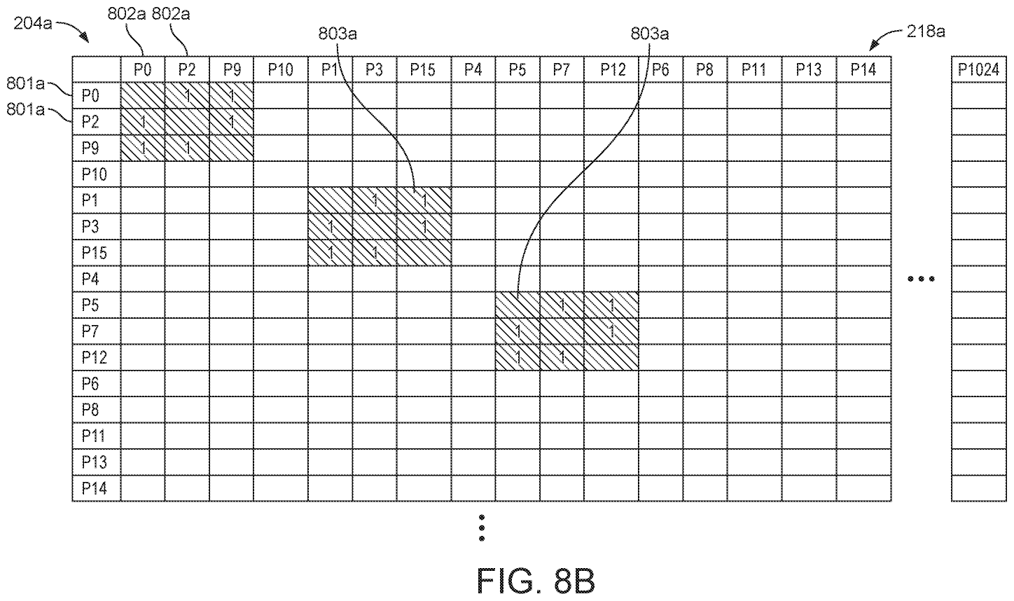

FIGS. 8A and 8B illustrate updating the initial adjacency matrix 204 to generate the updated adjacency matrix 204a.

As shown in FIG. 8A, the initial adjacency matrix 204 has rows 801 and columns 802 each corresponding to a data point in the set of data points 218 arranged in the initial order of data points (P0, P1, P2, P3, P4 . . . P1024). A matrix entry (element) is set to non-zero (1) where there is a connection between the data points in question, and to zero where no connection between the data points in question is present (exists).

As can be seen from FIG. 8A, the connections (non-zero entries) in the initial adjacency matrix are sparsely distributed in the sense of being thinly dispersed or scattered, and may have an appearance resembling a random or arbitrary distribution.

The initial adjacency matrix is also sparse, having a sparsity of roughly 93% (where the sparsity is the percentage of null (zero) elements (entries) compared to the total number of matrix elements). The initial adjacency matrix could contain fewer or more connections, and thus have a greater or lesser sparsity if desired. However, in an embodiment the adjacency matrices which are used in embodiments of the technology described herein have a sparsity greater than or equal to 70%, in an embodiment greater than or equal to 90%, in an embodiment greater than or equal to 94%, in an embodiment greater than or equal to 98%.

In order to generate the updated adjacency matrix 204a, the NRU 301 re-orders the rows and columns of the initial adjacency matrix 204 to correspond to the determined (new) order of data points 218a (as determined by using the space filling curve in processing stages 303 and 304). The determined (new) order of data points 218a being P0, P2, P9, P10, P1, P3, P15, P4, P5, P7, P12, P6, P8, P11, P13, P14 . . . P1024.

Thus, in the updated adjacency matrix 204a generated by the NRU 301, the rows 801a and columns 802a each corresponding to a data point in the set of data points 218a are arranged in the determined (new) order of data points. The NRU 301 sets a matrix entry (element) to non-zero (1) where there is a connection between the data points in question, and to zero where no connection between the data points in question is present (exists).

As can be seen from FIGS. 8A and 8B, the underlying connections between the data points represented in the initial adjacency matrix 204 and the updated adjacency matrix 204a are the same. For example, in both the initial adjacency matrix 204 and the updated adjacency matrix 204a there is a connection between data points P0 and P2, and a connection between data points P1 and P3, etc. Thus, the number of and particular connections represented in the updated adjacency matrix 204a is the same as the initial adjacency matrix 204 (and so the updated adjacency matrix 204a and the initial adjacency matrix 204a have the same overall sparsity).

However, the manner in which the connection information is organised (presented) within the data structures of initial adjacency matrix 204 and the updated adjacency matrix 204a differs, due to differences between the initial data point order 218 and the determined (new) data point order 218a.

The Applicant has recognised that in this regard that since the determined (new) order of data points 218a should better reflect the positions in space of the data points and therefore the likely connections between data points, the updated adjacency matrix 204a, which is updated based on the determined (new) order of data points 218a, may be in a form which is more efficient for neural network processing.

As can be seen from FIGS. 8A and 8B, the processing that has been performed to generate the updated adjacency matrix 204a has resulted in non-zero matrix entries being concentrated into one or more regions 803a of the updated adjacency matrix. Thus, the updated adjacency matrix has one or more regions 803a which are more densely populated with non-zero entries (than the corresponding regions 803 of the initial adjacency matrix 204, or than the initial adjacency matrix 204 as a whole). The updated adjacency matrix 204a also has one or more regions in which no connections are indicated, having no non-zero entries.

Such an updated adjacency matrix 204a has better locality when stored in memory, and is also easier to compress for writing to memory and to decompress when reading from memory (compared to the corresponding (initial) adjacency matrix 204). This allows for more efficient neural network processing, especially for processes which require the adjacency matrix to be used (e.g. such as aggregation 219).

In this regard, the Applicant has also recognised that neural network processing using the updated adjacency matrix 803a can be performed using only the regions of greater density 803a of the updated adjacency matrix (and ignoring the regions containing no connections). This may further improve efficiency of neural network processing.

FIG. 9A shows another example initial adjacency matrix, with FIG. 9B showing a corresponding updated adjacency matrix which may be generated according to the processing of the technology described herein. Similarly to FIG. 8B, in FIG. 9B it can be seen that the non-zero matrix entries in the updated adjacency matrix (shown in FIG. 9B as white dots) are concentrated into regions of greater density.

The NRU 301 also generates updated data point information in the form of an updated (re-ordered) feature matrix 206a (see processing stage 306 in FIG. 3). Generating the updated feature matrix 206a in an embodiment comprises re-ordering the data point information (node features) to correspond to the determined (new) order of data points. This is shown in FIG. 3 where the data point information is ordered according to the determined (new) order P0, P2, P9, P10, P1 . . . P1024.

Since the updated data point information (updated feature matrix 206a) is based on the determined (new) order of data points, which is based on the position in space of the data points, the order of the data point information in the feature matrix generally reflects the proximity of the data points in space and the likely connections between data points. This has the effect, as illustrated in FIG. 3, that connected data points (e.g. data points within the same cluster) have associated data point information which is generally closer together within the updated feature matrix. This can be seen illustratively in the grouping of data points in the same cluster, having the same shading, in the new data point order P0, P2, P9, P10, P1 . . . P1024.

The updated connectivity information (updated adjacency matrix 204a) and the updated data point information (updated feature matrix 206a) generated by the NRU (301) are then provided for further processing.

The further processing may comprise the same type of processing as described with respect to FIG. 2 (e.g. aggregation (219), processing by MLP (207), activation (208), pooling (209)), to provide any suitable and desired output data (216a).

At any point before or during the further processing (219, 207, 208, 209), the updated connectivity information (updated adjacency matrix 204a) and the updated data point information (updated feature matrix 206a) may either (or both) be stored in memory, if desired. The updated connectivity information (updated adjacency matrix 204a) may be compressed prior to storage in memory.

The updated data point information (updated feature matrix 206a) may be particularly efficient for performing neural network processing which requires the updated data point information to be used in combination with the updated adjacency matrix (e.g. during aggregation 219). The updated data point information will have good memory locality at least for such processing.

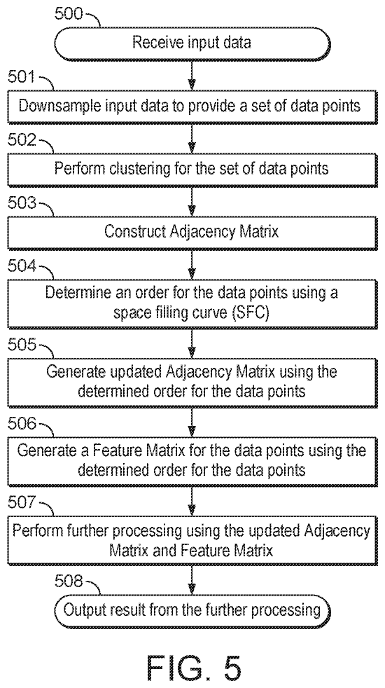

FIG. 5 is a flowchart showing processing that is performed in embodiments of the technology described herein.

As shown in FIG. 5, input data is received (step 500). As discussed above, the input data may comprise a set of input data points, e.g. corresponding to a point cloud. The input data points each correspond to a position in space.

The input data is downsampled (step 501) to provide a set of data points which are desired to be analysed according to neural network processing.

The set of data points is processed according to a clustering operation (step 502), which assigns data points to groups (“clusters”) and generates connections between the data points (in an embodiment wherein connections exist between data points within a cluster, and few or no connections exist between data points in different clusters).

Connectivity information in the form of an adjacency matrix is constructed (step 503) which indicates the connections between data points. The rows and columns of this (initial) adjacency matrix are ordered according to the order in which data points of the set of data points are received. This may be an arbitrary order.

A (new) order for the data points is determined (step 504) based on the positions in space of the data points, using a space filling curve.

Updated connectivity information in the form an updated adjacency matrix is generated (step 505) based on the (initial) adjacency matrix and the (new) determined order for the data points. In particular, the updated adjacency matrix indicates the same connections as the (initial) adjacency matrix, but the rows and columns of the updated adjacency matrix are ordered according to the (new) determined order for the data points.

An (updated) feature matrix is also generated (step 506) based on the determined order for the data points.

Further processing is performed (step 507) using the updated adjacency matrix and the (updated) feature matrix. The further processing comprises neural network processing.

The result from the further processing is output (step 508). This result may be any suitable and desired result inferred from the set of data points, e.g. a classification based on the set of data points.

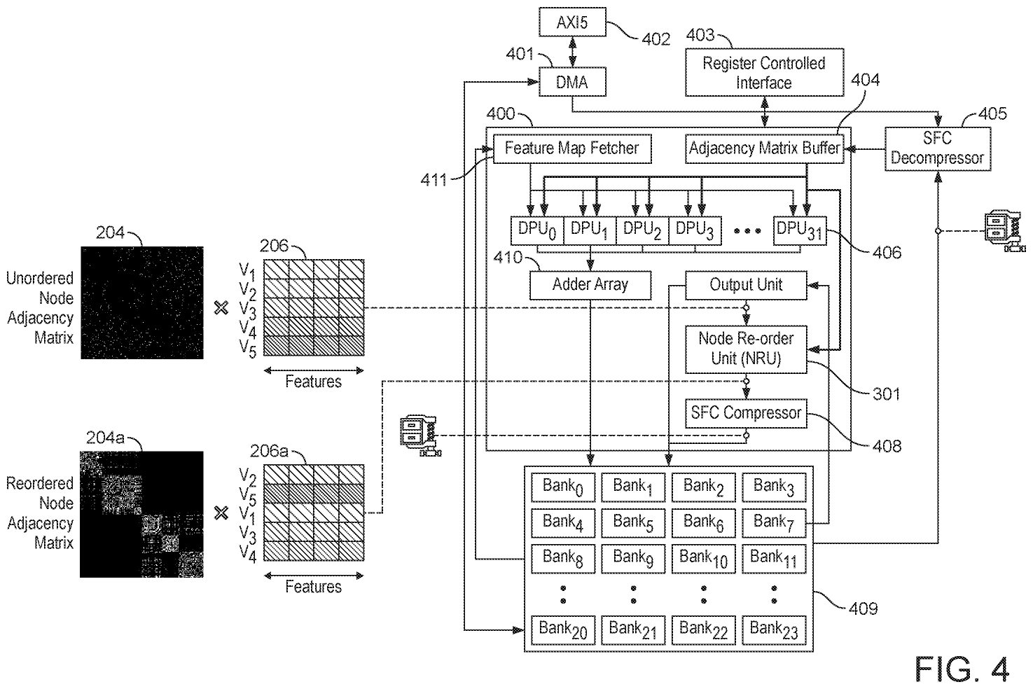

FIG. 4 shows schematically features of a processor 400 in accordance with embodiments of the technology described herein, which is operable to execute neural network processing. In the embodiment shown in FIG. 4, the processor 400 is a neural network processor (a Neural Processing Unit (NPU)), specifically configured for performing neural network processing.

The NPU 400 comprises a MAC unit (circuit) for performing Multiply Accumulate (MAC) operations (as may be required for various layers of neural network processing, such as aggregations layers, fully connected layers, convolutional layers, etc.). The MAC unit (circuit) comprises a plurality of dot product units (circuits) (DPU₀ . . . DPU₃₁) 406, and an adder array 410.

The NPU 400 is operable to perform neural network processing using the MAC circuit for (at least part of) a feature matrix and/or adjacency matrix.

The feature matrix and/or adjacency matrix may be stored in a main memory of the data processing system (e.g. being stored in main memory prior to commencing one or more layers of neural network processing, and/or being written to main memory after one or more layers of neural network processing).

The NPU 400 has a suitable interface for accessing data from (and sending data to) the main memory, comprising a direct memory access (DMA) unit 401 and a suitable connection 402 such as AXI5.

The NPU 400 is also in communication with a local memory (e.g. cache) 409. Data retrieved from main memory may be stored in the local memory 409 for use by the NPU.

The NPU 400 comprises an adjacency matrix buffer 404 for storing (at least part of) an adjacency matrix which is to be processed (or which is being processed) by neural network processing. The NPU 400 also comprises a feature matrix fetcher (feature matrix fetching circuit and/or buffer) 411 operable to retrieve information relating to (at least part of) a feature matrix from the local memory 409 for processing according to neural processing.

At least the adjacency matrix may be stored in a compressed form in the main memory (and potentially also in the local memory 409). As such, a decompressor (decompressor circuit) 405 is provided for decompressing the adjacency matrix for use by the NPU 400.

The NPU 400 is controlled via a suitable register controlled interface 403. Other arrangements would, of course, be possible.

In the embodiment shown in FIG. 4, the processing circuit 301 (Node Reordering unit, NRU) which is configured for generating updated connectivity information (updated adjacency matrix 204a) and updated data point information (updated feature matrix 206a), is provided as part of the NPU 400. A compressor 408 is also provided as part of the NPU 400 for compressing at least the updated adjacency matrix.

The NPU is operable to store in the local memory 409 information generated during neural network processing (by the MAC unit) and/or information relating to generation of an updated adjacency matrix and updated feature matrix.

From the above disclosure, it can be seen that the technology described herein comprises methods and systems for performing neural network processing for a set of data points each having a position in space, wherein processing is performed to provide connectivity information and data point information for the set of data points in a manner which can help improve the efficiency of the neural network processing.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a data processing system, the data processing system comprising a processor operable to execute neural network processing, the method comprising:
receiving for a set of data points, each data point corresponding to a position in space, data point information indicative of one or more properties of the data points, and connectivity information indicative of connections between data points of the set of data points;
determining an order for the data points of the set of data points, based on the positions in space of the data points;
generating updated connectivity information for the set of data points based on the received connectivity information and on the determined order for the data points; and
the processor performing neural network processing using the updated connectivity information for the set of data points.

2. The method of claim 1, comprising first generating the connectivity information from which updated connectivity information is generated, by determining one or more connections between data points.

3. The method of claim 1,
wherein generating the updated connectivity information comprises reordering the connectivity information according to the determined order for the data points.

4. The method of claim 1, wherein the connectivity information is in the form of an adjacency matrix, having rows and columns each corresponding to a respective data point in the order of the received set of data points, with non-zero matrix entries representing connections between data points, and zero matrix entries indicating that no connection between data points is present; and
wherein generating updated connectivity information comprises re-ordering the rows and columns of the adjacency matrix to correspond to the determined order for the data points in the set of data points.

5. The method of claim 1, comprising using a space filling curve to determine the order for the data points of the set of data points based on the positions in space of the data points.

6. The method of claim 1, further comprising generating updated data point information, based on the received data point information and on the determined order for the data points; and
wherein the processor uses the updated data point information for performing the neural network processing.

7. The method of claim 6, wherein generating the updated data point information comprises re-ordering the received data point information according to the determined order for the data points.

8. The method of claim 1, wherein providing the updated connectivity information for the set of data points for further processing by the processor comprises compressing the updated connectivity information and storing the compressed connectivity information in a storage of the data processing system.

9. The method of claim 1, wherein the connectivity information forms a data structure indicating connections between data points of the set of data points;
wherein the updated connectivity information forms a data structure with one or more regions having a greater density of indicated connections; and
comprising, when performing neural network processing using the updated connectivity information, only using said one or more regions having a greater density of indicated connections for the neural network processing.

10. (canceled)

11. A data processing system for performing neural network processing, the data processing system comprising:
a processor operable to execute neural network processing; and
a processing circuit configured to:
for a set of data points, each data point corresponding to a position in space, the set of data points having associated data point information indicative of one or more properties of the data points, and connectivity information indicative of connections between data points of the set of data points:
determine an order for the data points of the set of data points, based on the position in space of the data points;
generate updated connectivity information for the set of data points based on the connectivity information associated with the set of data points and on the determined order for the data points;
provide the updated connectivity information for the set of data points and the data point information for the set of data points for processing by the processor.

12. The data processing system of claim 11, wherein the processing circuit is configured to generate the connectivity information, wherein generating the connectivity information comprises determining one or more connections between data points.

13. The data processing system of claim 11, wherein the processing circuit is configured to generate updated connectivity information by re-ordering the connectivity information associated with the set of data points, according to the determined order for the data points.

14. The data processing system of claim 11, wherein the connectivity information associated with the set of data points is in the form of an adjacency matrix, having rows and columns each corresponding to a respective data point in an order of the set of data points as provided, with non-zero matrix entries representing connections between data points, and zero matrix entries indicating that no connection between data points is present; and
wherein the processing circuit is configured to generate updated connectivity information by re-ordering the rows and columns of the adjacency matrix associated with the set of data points to correspond to the determined order for the data points in the set of data points.

15. The data processing system of claim 11, wherein the processing circuit is configured to use a space filling curve to determine the order for the data points of the set of data points based on the position in space of the data points.

16. The data processing system of claim 11, wherein the processing circuit is configured to generate updated data point information, based on the data point information associated with the set of data points and on the determined order for the data points;
wherein the processing circuit is configured to provide updated data point information for further processing by the processor.

17. The data processing system of claim 16, wherein the processing circuit is configured to generate updated data point information by re-ordering the data point information associated with the set of data points, according to the determined order for the data points.

18. The data processing system of claim 11,
wherein the processing circuit is configured to provide updated connectivity information to a compression circuit for compression prior to storage of updated connectivity information;
and wherein the processor operable to perform neural network processing is operable to retrieve stored updated connectivity information for performing neural network processing.

19. The data processing system of claim 11, wherein the connectivity information associated with the set of data points forms a data structure indicating connections between data points of the set of data points;
wherein the updated connectivity information generated by the processing circuit forms a data structure with one or more regions having a greater density of indicated connections; and
the processor operable to perform neural network processing being configured to, when performing neural network processing using the updated connectivity information, only use said one or more regions having a greater density of indicated connections for neural network processing.

20. The data processing system of claim 11, wherein the processing circuit is incorporated within the processor operable to execute neural network processing.

21. A processing circuit for processing a set of data points, each corresponding to a position in space, the set of data points having associated data point information indicative of one or more properties of the data points, and connectivity information indicative of connections between data points of the set of data points, the processing circuit configured to:
determine an order for the data points of the set of data points, based on the position in space of the data points; and
generate updated connectivity information for the set of data points based on the connectivity information associated with the set of data points and on the determined order for the data points.

22. (canceled)

23. A non-transitory computer readable storage medium storing computer software code which when executing on at least one processor performs a method of operating a data processing system, the data processing system comprising a processor operable to execute neural network processing, the method comprising:
receiving for a set of data points, each data point corresponding to a position in space, data point information indicative of one or more properties of the data points, and connectivity information indicative of connections between data points of the set of data points;
determining an order for the data points of the set of data points, based on the positions in space of the data points;
generating updated connectivity information for the set of data points based on the received connectivity information and on the determined order for the data points; and
the processor performing neural network processing using the updated connectivity information for the set of data points.
